(19) United States
(12) Patent Application Publication
(10) Pub. No.: US 2025/0242356 A1
(43) Pub. Date: Jul. 31, 2025

(54) MAGNESIUM POWDER PULVERIZING AND GRINDING DEVICE

(71) Applicant: Shanxi Fuhengdi New Materials Co., Ltd., Yuncheng City (CN)

(72) Inventors: Juncai CHAI, Yuncheng City (CN); Junping LI, Yuncheng City (CN); Kun ZHAO, Yuncheng City (CN)

(21) Appl. No.: 18/978,767

(22) Filed: Dec. 12, 2024

(30) Foreign Application Priority Data
Jan. 31, 2024 (CN) 202410139461.0

(51) Int. Cl. B02C 23/08; B02C 19/16

(52) U.S. Cl. CPC B02C 23/08; B02C 19/16

(57) ABSTRACT

A magnesium powder pulverizing and grinding device is provided, relating to the technical field of magnesium powder pulverizing. The device includes a mounting frame, a storage barrel is fixedly mounted on the mounting frame, a filter plate is rotatably mounted on an inner side wall of the storage barrel, and a pulverizing mechanism is connected to the filter plate. The pulverizing mechanism is used to pulverize caked magnesium powder. A grinding mechanism is connected to the filter plate, and the grinding mechanism is used to grind the pulverized magnesium powder. A vibration mechanism is connected to the grinding mechanism, and the vibration mechanism is used to accelerate the falling of the pulverized magnesium powder. The effect of improving the use convenience of the magnesium powder pulverizing and grinding device is achieved.

### CROSS-REFERENCE TO RELATED APPLICATION

This patent application claims the benefit and priority of Chinese Patent Application No. 202410139461.0, filed with the China National Intellectual Property Administration on Jan. 31, 2024, the disclosure of which is incorporated by reference herein in its entirety as part of the present application.

### TECHNICAL FIELD

The present disclosure relates to the technical field of magnesium powder pulverization, and in particular to a magnesium powder pulverizing and grinding device.

### BACKGROUND

Magnesium powder is a white powder, scientifically known as “magnesium carbonate”, and commonly named “magnesium powder”. The magnesium powder is widely used in gymnastics, rings, weightlifting and other sports due to its light weight and strong moisture absorption. Before the competition, athletes usually smear magnesium powder on their palms to ensure that the palms are dry during the exercise, thus avoiding the influence of sweat on the movement quality of the athletes and protecting their personal safety.

Magnesium powder is usually packaged in cans when leaving the factory. Athletes cannot use the entire each time, unspent magnesium powder often cakes due to improper storage, and therefore the caked magnesium powder needs to be pulverized and ground to ensure the effectiveness of the magnesium powder.

Places with large demand for magnesium powder (such as gymnasiums) often need to pulverize and grind caked magnesium powder, manual grinding is time-consuming and laborious, while automatic grinding devices are mostly large pulverizers, which cannot meet the daily needs of the above places.

### SUMMARY

In order to improve the use convenience of a magnesium powder pulverizing and grinding device, a magnesium powder pulverizing and grinding device is provided.

A magnesium powder pulverizing and grinding device provided by the present disclosure employs the following technical solutions:

A magnesium powder pulverizing and grinding device includes a mounting frame. A storage barrel is fixedly mounted on the mounting frame, a filter plate is rotatably mounted on an inner side wall of the storage barrel, and a pulverizing mechanism is connected to the filter plate, and is used to pulverize caked magnesium powder. A grinding mechanism is connected to the filter plate, and is used to grind the pulverized magnesium powder. A vibration mechanism is connected to the grinding mechanism, and is used to accelerate the falling of the pulverized magnesium powder. The pulverizing mechanism includes:
a pulverizing barrel, where the pulverizing barrel is a hollow cylinder, multiple filter holes are formed in a side wall of the pulverizing barrel, filtering accuracy of the filter plate is greater than that of the side wall of the pulverizing barrel, the pulverizing barrel is coaxially and fixedly connected to the filter plate, and one end, away from the filter plate, of the pulverizing barrel is arranged on a top wall of the pulverizing barrel in a penetrating manner, and is coaxially and rotatably connected to the top wall of the pulverizing barrel;
a first rotating shaft, where one end, away from the filter plate, of the first rotating shaft is coaxially and rotatably connected to an inner wall of the pulverizing barrel, and the first rotating shaft is located in the pulverizing barrel;
multiple pulverizing blades, where the pulverizing blades are fixedly mounted on a side wall of the first rotating shaft, and can pulverize caked magnesium powder in the pulverizing barrel; and
a driving assembly, connected to the first rotating shaft and capable of driving the first rotating shaft to rotate.

By adopting the technical solution above, the driving assembly drives the first rotating shaft, the first rotating shaft drives the pulverizing blades rotating to pulverize the caked magnesium powder added in the pulverizing barrel. Part of the magnesium powder pulverized by the pulverizing blades reaches the use requirement, and the magnesium powder with the use requirement falls from the filter plate. Part of small-particle magnesium powder is thrown out from the side wall of the pulverizing barrel, enters the grinding mechanism for grinding, and falls from the filter plate after grinding. Part of the large-particle magnesium powder remains in the pulverizing barrel for continually pulverizing. Meanwhile, the vibration mechanism operates to vibrate the filter plate, so as to accelerate the falling of the magnesium powder meeting the use fineness. Therefore, the use convenience of the magnesium powder pulverizing and grinding device is improved.

Alternatively, the driving assembly includes:
a motor, fixedly mounted on the mounting frame;
a first bevel gear, coaxially and fixedly mounted on an output end of the motor; and
a second bevel gear, coaxially and fixedly mounted on the first rotating shaft, where the first bevel gear is meshed with the second bevel gear.

By adopting the above technical solution, the motor operates to drive the first bevel gear, the first bevel gear drives the second bevel gear to rotate, the second bevel gear drives the first rotating shaft, and the first rotating shaft drives the pulverizing blades to rotate to pulverize the caked magnesium powder. Therefore, the use convenience of the magnesium powder pulverizing and grinding device is improved.

Alternatively, the grinding mechanism includes:
multiple second rotating shafts, where the multiple second rotating shafts are circumferentially arranged with an axis of the pulverizing barrel as the center, and are all rotatably mounted on the filter plate;
multiple grinding columns, where the multiple grinding columns are in one-to-one correspondence with and are coaxially and fixedly connected to the multiple second rotating shafts, a side wall of each grinding column can be abutted against an inner wall of the storage barrel, and the side wall of the grinding column can be abutted against an outer wall of the pulverizing barrel; and
a transmission assembly, connected to the second rotating shaft and capable of driving the second rotating shaft to rotate.

By adopting the above technical solution, the transmission assembly operates to drive the second rotating shaft, the second rotating shaft drives the grinding columns to rotate, making side walls of the grinding columns and an inner wall of the storage barrel to squeeze the caked magnesium powder, so as to achieve the pulverizing and grinding of the magnesium powder. Therefore, the use convenience of the magnesium powder pulverizing and grinding device is improved.

Alternatively, the transmission assembly includes:
a third bevel gear, coaxially and fixedly connected to the output end of the motor;
a fourth bevel gear, coaxially and fixedly connected to the pulverizing barrel, where the third bevel gear is meshed with the fourth bevel gear;
a first gear, coaxially and fixedly connected to the pulverizing barrel; and
multiple second gears, where the multiple second gears are in one-to-one correspondence with and coaxially and fixedly connected to and the multiple second rotating shafts, and the first gear is meshed with the multiple second gears.

By adopting the above technical solution, the motor operates to drive the third bevel gear, the third bevel gear drives the fourth bevel gear, the fourth bevel gear drives the pulverizing barrel, the pulverizing barrel drives the first gear, the first gear drives the second gear, the second gear drives the second rotating shaft to rotate, thus driving the grinding columns to rotate to pulverize the magnesium powder. Therefore, the use convenience of the magnesium powder pulverizing and grinding device is improved.

Alternatively, the vibration mechanism includes:
multiple telescopic rods, where fixed ends of the plurality of telescopic rods are in one-to-one correspondence with and fixedly mounted on side walls of the plurality of second rotating shafts, and movable ends of the telescopic rods are along a radius direction of the second rotating shafts; and
multiple springs, where ends of the multiple springs are in one-to-one correspondence with and fixedly connected to fixed ends of the plurality of telescopic rods, and the other ends of the multiple springs are in one-to-one correspondence with and fixedly connected to the movable ends of the multiple telescopic rods.

By adopting the above technical solution, the second rotating shafts rotate to drive the telescopic rods to rotate, the telescopic rods rotate to knock the inner wall of the storage barrel, which further makes the filter plate to vibrate to accelerate the falling of the magnesium powder after pulverizing. The second rotating shaft continues to rotate, the movable ends of the telescopic rods retract under the blockage of the inner wall of the storage barrel, and the springs are compressed. When the second rotating shaft rotates until the movable ends of the telescopic rods are no longer abutted against the inner wall of the storage barrel, the springs make the telescopic rods extend out to prepare for the next knock. Therefore, the use convenience of the magnesium powder pulverizing and grinding device is improved.

Alternatively, a feeding mechanism is arranged on one end, away from the filter plate, of the pulverizing barrel. The feeding mechanism includes:
a rotating ring, embedded and rotatably mounted on a side wall of the pulverizing barrel; and
a feeding pipe, where one end of the feeding pipe is rotatably connected to the rotating ring and communicates with the pulverizing barrel, the feeding pipe is fixedly connected to the mounting frame and is obliquely arranged, and one end, fixedly connected to the rotating ring, of the feeding pipe is a low end.

By adopting the above technical solution, the caked magnesium powder is added into the pulverizing barrel from a high end of the feeding pipe during use. When the pulverizing barrel rotates, the rotating ring is stationary with respect to the feeding pipe to avoid interference to the rotation of the pulverizing barre. Therefore, the use convenience of the magnesium powder pulverizing and grinding device is improved.

Alternatively, one end, away from the rotating ring, of the feeding pipe is flared.

By adopting the above technical solution, the magnesium powder can be added into the pulverizing barrier easier, the pulverizing efficiency is improved, and thus the use convenience of the magnesium powder pulverizing and grinding device is improved.

Alternatively, a funnel is fixedly mounted on an inner side wall of the storage barrel and is located below the filter plate, a flared end of the funnel is fixedly connected to the inner side wall of the storage barrel, and a necked end of the funnel penetrates through a bottom wall of the storage barrel.

By adopting the technical solution above, the magnesium powder falling from the filter plate can be collected to facilitate the subpackage of the pulverized magnesium powder. Therefore, the use convenience of the magnesium powder pulverizing and grinding device is improved. Alternatively, a valve is fixedly connected to the necked end of the funnel.

By adopting the technical solution above, the opening and closing of the funnel are controlled in the subpackage process of the magnesium powder after pulverizing, so as to facilitate the subpackage of the pulverized magnesium powder. Therefore, the use convenience of the magnesium powder pulverizing and grinding device is improved.

In conclusion, the present disclosure includes at least one of the following beneficial effects:
1. The driving assembly drives the first rotating shaft, the first rotating shaft drives the pulverizing blades to rotate to pulverize the caked magnesium powder added in the pulverizing barrel. Part of the magnesium powder pulverized by the pulverizing blades meets the use requirement, and the magnesium powder with the use requirement falls from the filter plate. Part of small-particle magnesium powder is thrown out from the side wall of the pulverizing barrel, enters the grinding mechanism for grinding, and falls from the filter plate after grinding. Part of the large-particle magnesium powder remains in the pulverizing barrel for continuous pulverizing. Meanwhile, the vibration mechanism operates to vibrate the filter plate, so as to accelerate the falling of the magnesium powder meeting the use fineness. Therefore, the use convenience of the magnesium powder pulverizing and grinding device is improved.
2. The transmission assembly operates to drive the second rotating shafts to rotate, the second rotating shafts rotate to drive the grinding columns to rotate, making side walls of the grinding columns and an inner wall of the storage barrel to squeeze the caked magnesium powder, so as to achieve the pulverizing and grinding of the magnesium powder. Therefore, the use convenience of the magnesium powder pulverizing and grinding device is improved.
3. The second rotating shaft rotates to drive the telescopic rods to rotate, the telescopic rods rotate to knock the inner wall of the storage barrel, which further makes the filter plate to vibrate to accelerate the falling of the magnesium powder after pulverizing. The second rotating shaft continues to rotate, the movable ends of the telescopic rods retract under the blockage of the inner wall of the storage barrel, and the springs are compressed. When the second rotating shaft rotates until the movable ends of the telescopic rods are no longer abutted against the inner wall of the storage barrel, the springs make the telescopic rods extend out to prepare for the next knock. Therefore, the use convenience of the magnesium powder pulverizing and grinding device is improved.

### BRIEF DESCRIPTION OF THE DRAWINGS

FIG. 1 is a structural schematic diagram of an embodiment of the present disclosure;

FIG. 2 is a structural illustration diagram of a grinding mechanism according to an embodiment of the present disclosure;

FIG. 3 is an enlarged view of place A in FIG. 2 according to an embodiment of the present disclosure.

In the drawings:
1—mounting frame;
2—storage barrel; 21—filter plate;
31—pulverizing barrel; 32—filter hole; 33—first rotating shaft; 34—pulverizing blade; 35—driving assembly; 351—motor; 352—first bevel gear; 353—second bevel gear;
4—grinding mechanism; 41—second rotating shaft; 42—grinding column; 43—transmission assembly; 431—third bevel gear; 432—fourth bevel gear; 433—first gear; 434—second gear;
5—vibration mechanism; 51—telescopic rod; 52—spring;
6—feeding mechanism; 61—rotating ring; 62—feeding pipe;
7—funnel;
8—valve.

### DETAILED DESCRIPTION OF THE EMBODIMENTS

The present disclosure is further described in detail below with reference to the accompanying drawings 1-3.

A magnesium powder pulverizing and grinding device is provided by an embodiment of the present disclosure.

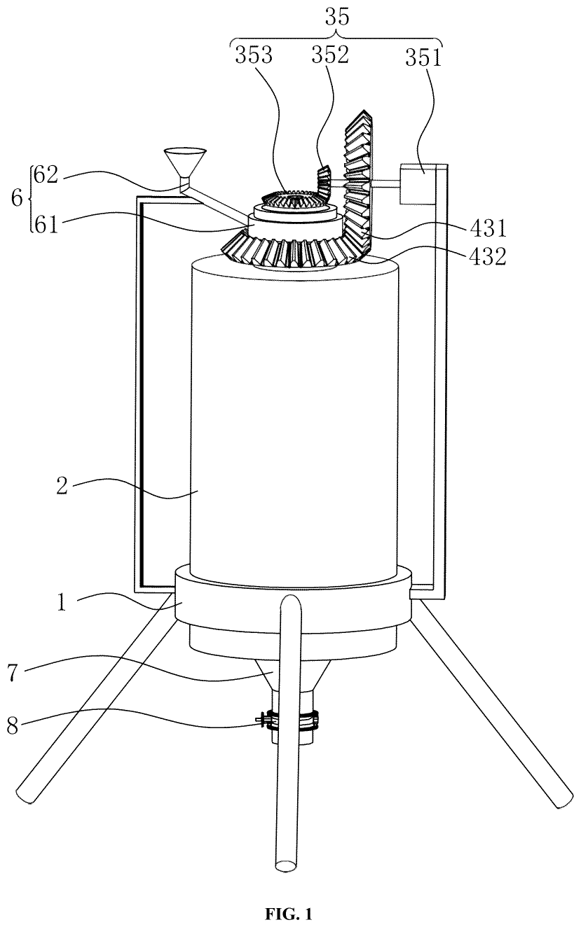

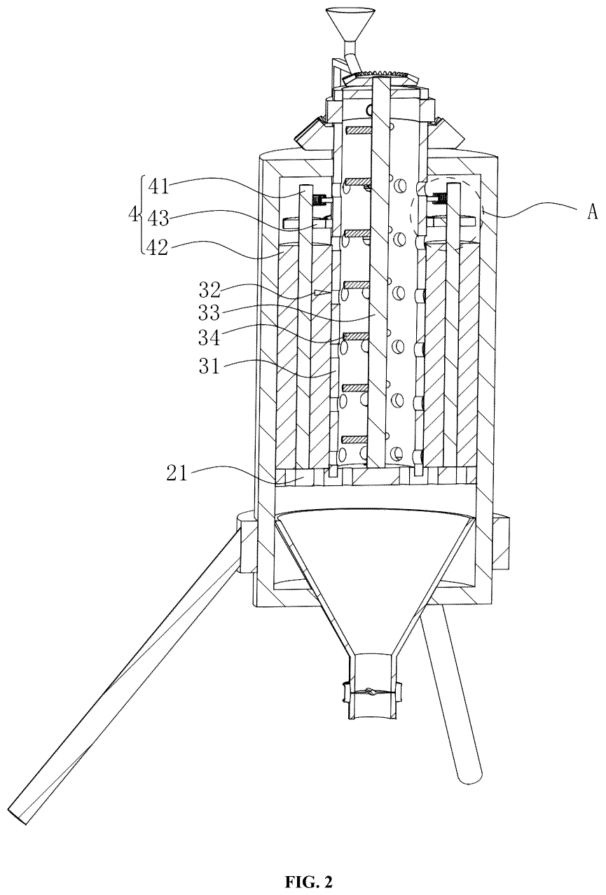

Referring to FIG. 1 and FIG. 2, a magnesium powder pulverizing and grinding device includes a mounting frame 1. A storage barrel 2 is fixedly mounted on the mounting frame 1, a filter plate 21 is rotatably mounted on an inner side wall of the storage barrel 2, and a pulverizing mechanism is connected to the filter plate 21, and is used to pulverize agglomerated magnesium powder. A grinding mechanism 4 is connected to the filter plate 21, and is used to grind the pulverized magnesium powder. A vibration mechanism 5 is connected to the grinding mechanism 4, and is used to accelerate the falling of the pulverized magnesium powder.

Referring to FIG. 2, the pulverizing mechanism includes a pulverizing barrel 31. Multiple filter holes 32 are formed in a side wall of the pulverizing barrel 31, and filtering accuracy of the filter plate 21 is greater than that of the side wall of the pulverizing barrel 31. The pulverizing barrel 31 is coaxially and fixedly connected to the filter plate 21, and one end, away from the filter plate 21, of the pulverizing barrel 31 is arranged on a top wall of the pulverizing barrel 31 in a penetrating manner, and is coaxially and rotatably connected to the top wall of the pulverizing barrel 31. A first rotating shaft 33 is coaxially and rotatably connected to an inner wall of the pulverizing barrel 31, and located in the pulverizing barrel 31. Multiple pulverizing blades 34 are uniformly distributed and fixedly mounted on a side wall of the first rotating shaft 33, and can pulverize caked magnesium powder in the pulverizing barrel 31. A driving assembly 35 is connected to the first rotating shaft 33 and capable of driving the first rotating shaft 33 to rotate.

Before using, the caked magnesium powder is added into the pulverizing barrel 31. The driving assembly 35 is started to drive the first rotating shaft 33 to rotate, the first rotating shaft 33 rotates to drive the pulverizing blades 34 to rotate to pulverize the caked magnesium powder. Part of the magnesium powder pulverized by the pulverizing blades 34 reaches the use fineness, and the magnesium powder with the use fineness falls from the filter plate 21. Part of small-particle magnesium powder is thrown out from the side wall of the pulverizing barrel 31, enters the grinding mechanism 4 for grinding, and falls from the filter plate 21 after grinding. Part of the large-particle magnesium powder remains in the pulverizing barrel 31 for continuous pulverizing. Meanwhile, the vibration mechanism 5 operates to vibrate the filter plate 21, so as to accelerate the falling of the magnesium powder meeting the use fineness.

Referring to FIG. 1, the driving assembly 35 includes a motor 351, and the motor 351 is fixedly mounted on the mounting frame 1. A first bevel gear 352 is coaxially and fixedly mounted on an output end of the motor 351. The first bevel 352 is meshed with a second bevel gear 353, and the second bevel gear 353 is coaxially and fixedly mounted on the first rotating shaft 33.

During use, the motor 351 operates to drive the first bevel gear 352 to rotate, the first bevel gear 352 rotates to drive the second bevel gear 353 to rotate, the second bevel gear 353 rotates to drive the first rotating shaft 33 to rotate, and the first rotating shaft 33 rotates to drive the pulverizing blades 34 to rotate to pulverize the caked magnesium powder.

Referring to FIG. 2, the grinding mechanism 4 includes four second rotating shafts 41, the four second rotating shafts 41 are circumferentially arranged with an axis of the pulverizing barrel 31 as the center, and the four second rotating shafts 41 are all rotatably mounted on the filter plate 21. Grinding columns 42 are in one-to-one correspondence with and coaxially and fixedly connected to the four second rotating shafts 41, a side wall of each grinding column 42 can be abutted against an inner wall of the storage barrel 2, and the side wall of the grinding column 42 can be abutted against an outer wall of the pulverizing barrel 31. A transmission assembly 43 is connected to the second rotating shafts 41, and the transmission assembly 43 can drive the second rotating shafts 41 to rotate.

During use, the transmission assembly 43 operates to drive the second rotating shafts 41 to rotate, the second rotating shafts 41 rotate to drive the grinding columns 42 to rotate, making the side walls of the grinding columns 42 and the inner wall of the storage barrel 2 to squeeze the caked magnesium powder, so as to achieve the pulverizing and grinding of the magnesium powder.

Referring to FIG. 1 to FIG. 3, the transmission assembly 43 includes a third bevel gear 431, and the third bevel gear 431 is coaxially and fixedly connected to the output end of the motor 351. The third bevel gear 431 is meshed with a fourth bevel gear 432, and the fourth bevel gear 432 is coaxially and fixedly connected to the pulverizing barrel 31. The pulverizing barrel 31 is coaxially and fixedly connected to a first gear 433, and the first gear 433 is meshed with four second gears 434, and the second gears 434 are in one-to-one correspondence with and coaxially and fixedly connected to the second rotating shafts 41.

During use, the motor 351 operates to drive the third bevel gear 431 to rotate, the third bevel gear 431 rotates to drive the fourth bevel gear 432 to rotate, the fourth bevel gear 432 drives the pulverizing barrel 31 to rotate, the pulverizing barrel 31 drives the first gear 433 to rotate, the first gear 433 drives the second gears 434 to rotate, the second gears 434 drive the second rotating shafts 41 to rotate, thus driving the grinding columns 42 to rotate to pulverize the magnesium powder.

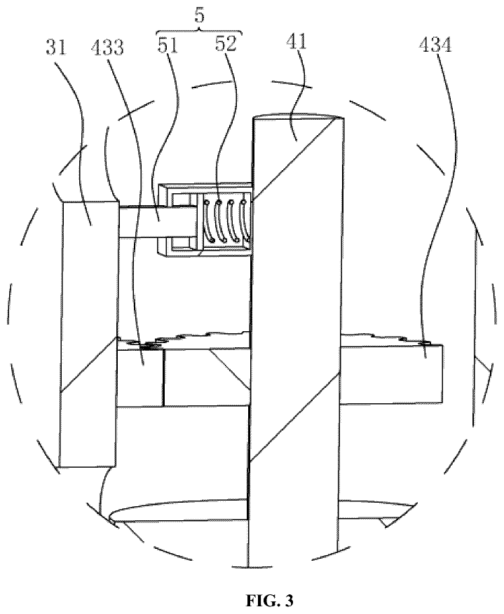

Referring to FIG. 3, the vibration mechanism 5 includes four telescopic rods 51. Fixed ends of the four telescopic rods 51 are in one-to-one correspondence with and fixedly mounted on side walls of the second rotating shafts 41, and movable ends of the telescopic rods 51 along a radius direction of the second rotating shafts 41. Four springs 52 are fixedly mounted in rodless cavities of the four telescopic rods 51 in one-to-one correspondence, one end of each spring 52 is fixedly connected to the fixed end of the telescopic rod 51, and the other end of the spring 52 is fixedly connected to the movable end of the telescopic rod 51.

During use, the second rotating shafts 41 rotate to drive the telescopic rods 51 to rotate, the telescopic rods 51 rotate to knock the inner wall of the storage barrel 2, which further makes the filter plate 21 to vibrate to accelerate the falling of the magnesium powder after pulverizing. At this time, the second rotating shafts 41 continue to rotate, the movable ends of the telescopic rods 51 retract under the blockage of the inner wall of the storage barrel 2, and the springs 52 are compressed. When the second rotating shafts 41 rotate until the movable ends of the telescopic rods 51 are no longer abutted against the inner wall of the storage barrel 2, the springs 52 make the telescopic rods 51 extend out to prepare for the next knock.

Referring to FIG. 2, a feeding mechanism 6 is arranged on one end, away from the filter plate 21, of the pulverizing barrel 31, and includes a rotating ring 61. The rotating ring 61 is embedded and rotatably mounted on the side wall of the pulverizing barrel 31. The rotating ring 61 is rotatably connected to one end of the feeding pipe 62, and communicates with the pulverizing barrel 31. The feeding pipe 62 is fixedly connected to the mounting frame 1, and is obliquely arranged. One end, fixedly connected to the rotating ring, of the feeding pipe 62 is a low end.

Before use, the caked magnesium powder is added into the pulverizing barrel 31 from a high end of the feeding pipe 62. When the pulverizing barrel 31 rotates, the rotating ring 61 is stationary with respect to the feeding pipe 62, thus avoiding interference to the rotation of the pulverizing barrel 31.

Referring to FIG. 1, one end, away from the rotating ring 61, of the feeding pipe 62 is flared.

The magnesium powder can be added into the pulverizing barrel 31 easier through the flared end, which is conducive to improving the pulverizing efficiency.

Referring to FIG. 1, a funnel 7 is fixedly mounted on an inner side wall of the storage barrel 2, and the funnel 7 is located below the filter plate 21. A flared end of the funnel 21 is fixedly connected to the inner side wall of the storage barrel 2, and a necked end of the funnel 7 penetrates through a bottom wall of the storage barrel 2.

The magnesium powder falling from the filter plate 21 can be collected by the funnel 7, thus facilitating the subpackage of the pulverized magnesium powder.

Referring to FIG. 1, a valve 8 is fixedly connected to the necked end of the funnel 7.

The opening and closing of the funnel 7 can be controlled by the valve 8 in the subpackage process of the magnesium powder after pulverizing, thus facilitating the subpackage of the pulverized magnesium powder.

The implementation principle of the magnesium powder pulverizing and grinding device provided by an embodiment of the present disclosure is that before use, the caked magnesium powder is added into the pulverizing barrel 31 from the high end of the feeding pipe 62. The motor 351 is started, the motor 351 operates to drive the first bevel gear 352 to rotate, the first bevel gear 352 rotates to drive the second bevel gear 353 to rotate, the second bevel gear 353 rotates to drive the first rotating shaft 33 to rotate, and the first rotating shaft 33 rotates to drive the pulverizing blades 34 to rotate to pulverize the magnesium powder. Part of the magnesium powder pulverized by the pulverizing blades 34 reaches the use fineness, and the magnesium powder with the use fineness falls from the filter plate 21. Part of small-particle magnesium powder is thrown out from the side wall of the pulverizing barrel 31. At this time, the motor 351 operates to drive the third bevel gear 431 to rotate, the third bevel gear 431 rotates to drive the fourth bevel gear 432 to rotate, the fourth bevel gear 432 rotates to drive the pulverizing barrel 31 to rotate, the pulverizing barrel 31 rotates to drive the first gear 433 to rotate, the first gear 433 drives the second gears 434 to rotate, the second gears 434 rotate to drive the second rotating shafts 41 to rotate, thus driving the grinding columns 42 to rotate. The side walls of the grinding columns 42 and the inner wall of the storage barrel 2 squeeze the caked magnesium powder to grind the magnesium powder, and the magnesium powder after grinding falls from the filter plate 21. Part of large-particle magnesium powder remains in the pulverizing barrel 31 for continuous pulverizing, and thus the use convenience of the magnesium powder pulverizing and grinding device is improved.

The above information is the preferred embodiments of the present disclosure, and the scope of protection of the present disclosure is not limited accordingly. Therefore, all equivalent changes made according to the structure, shape and principle of the present disclosure should be included in the scope of protection of the present disclosure.

What is claimed is:

1. A magnesium powder pulverizing and grinding device, comprising a mounting frame (1), wherein a storage barrel (2) is fixedly mounted on the mounting frame (1), a filter plate (21) is rotatably mounted on an inner side wall of the storage barrel (2), and a pulverizing mechanism is connected to the filter plate (21), and is used to pulverize caked magnesium powder; a grinding mechanism (4) is connected to the filter plate (21), and is used to grind the pulverized magnesium powder; a vibration mechanism (5) is connected to the grinding mechanism (4), and is used to accelerate the falling of the pulverized magnesium powder; the pulverizing mechanism comprises:
a pulverizing barrel (31), wherein the pulverizing barrel (31) is a hollow cylinder, a plurality of filter holes (32) are formed in a side wall of the pulverizing barrel (31), filtering accuracy of the filter plate (21) is greater than that of the side wall of the pulverizing barrel (31), the pulverizing barrel (31) is coaxially and fixedly connected to the filter plate (21), and one end, away from the filter plate (21), of the pulverizing barrel (31) is arranged on a top wall of the pulverizing barrel (31) in a penetrating manner, and is coaxially and rotatably connected to the top wall of the pulverizing barrel (31);
a first rotating shaft (33), wherein one end, away from the filter plate (21), of the first rotating shaft (33) is coaxially and rotatably connected to an inner wall of the pulverizing barrel (31), and the first rotating shaft (33) is located in the pulverizing barrel (31);
a plurality of pulverizing blades (34), wherein the pulverizing blades (34) are fixedly mounted on a side wall of the first rotating shaft (33), and able to pulverize caked magnesium powder in the pulverizing barrel (31); and
a driving assembly (35), connected to the first rotating shaft (33) and capable of driving the first rotating shaft (33) to rotate.

2. The magnesium powder pulverizing and grinding device according to claim 1, wherein the driving assembly (35) comprises:
a motor (351), fixedly mounted on the mounting frame (1);
a first bevel gear (352), coaxially and fixedly mounted on an output end of the motor (351); and
a second bevel gear (353), coaxially and fixedly mounted on the first rotating shaft (33), wherein the first bevel gear (352) is meshed with the second bevel gear (353).

3. The magnesium powder pulverizing and grinding device according to claim 2, wherein the grinding mechanism (4) comprises:
a plurality of second rotating shafts (41), wherein the plurality of second rotating shafts (41) are circumferentially arranged with an axis of the pulverizing barrel (31) as the center, and are all rotatably mounted on the filter plate (21);
a plurality of grinding columns (42), wherein the plurality of grinding columns (42) are in one-to-one correspondence with and are coaxially and fixedly connected to the plurality of second rotating shafts (41), a side wall of each grinding column (42) is abutted against an inner wall of the storage barrel (2), and the side wall of the grinding column (42) is abutted against an outer wall of the pulverizing barrel (31); and
a transmission assembly (43), connected to the second rotating shaft (41) and capable of driving the second rotating shaft (41) to rotate.

4. The magnesium powder pulverizing and grinding device according to claim 3, wherein the transmission assembly (43) comprises:
a third bevel gear (431), coaxially and fixedly connected to an output end of the motor (351);
a fourth bevel gear (432), coaxially and fixedly connected to the pulverizing barrel (31), wherein the third bevel gear (431) is meshed with the fourth bevel gear (432);
a first gear (433), coaxially and fixedly connected to the pulverizing barrel (31); and
a plurality of second gears (434), wherein the plurality of second gears (434) are in one-to-one correspondence with and coaxially and fixedly connected to and the plurality of second rotating shafts (41), and the first gear (433) is meshed with the plurality of second gears (434).

5. The magnesium powder pulverizing and grinding device according to claim 3, wherein the vibration mechanism (5) comprises:
a plurality of telescopic rods (51), wherein fixed ends of the plurality of telescopic rods (51) are in one-to-one correspondence with and fixedly mounted on side walls of the plurality of second rotating shafts (41), and movable ends of the telescopic rods (51) are along a radius direction of the second rotating shafts (41); and
a plurality of springs (52), wherein ends of the plurality of springs (52) are in one-to-one correspondence with and fixedly connected to fixed ends of the plurality of telescopic rods (51), and the other ends of the plurality of springs (52) are in one-to-one correspondence with and fixedly connected to the movable ends of the plurality of telescopic rods (51).

6. The magnesium powder pulverizing and grinding device according to claim 1, wherein a feeding mechanism (6) is arranged on one end, away from the filter plate (21), of the pulverizing barrel (31), and the feeding mechanism (6) comprises:
a rotating ring (61), embedded and rotatably mounted on a side wall of the pulverizing barrel (31); and
a feeding pipe (62), wherein one end of the feeding pipe (62) is rotatably connected to the rotating ring (61) and communicates with the pulverizing barrel (31), the feeding pipe (62) is fixedly connected to the mounting frame (1) and is obliquely arranged, and one end, fixedly connected to the rotating ring (61), of the feeding pipe (62) is a low end.

7. The magnesium powder pulverizing and grinding device according to claim 6, wherein one end, away from the rotating ring (61), of the feeding pipe (62) is flared.

8. The magnesium powder pulverizing and grinding device according to claim 1, wherein a funnel (7) is fixedly mounted on an inner side wall of the storage barrel (2) and is located below the filter plate (21), a flared end of the funnel (7) is fixedly connected to the inner side wall of the storage barrel (2), and a necked end of the funnel (7) penetrates through a bottom wall of the storage barrel (2).

9. The magnesium powder pulverizing and grinding device according to claim 8, wherein a valve (8) is fixedly connected to the necked end of the funnel (7).
